(19) United States
(12) Patent Application Publication
(10) Pub. No.: US 2025/0382148 A1
(43) Pub. Date: Dec. 18, 2025

(54) MEDIUM DISCHARGE DEVICE AND ELECTRONIC DEVICE

(71) Applicant: SEIKO EPSON CORPORATION, TOKYO (JP)

(72) Inventor: Yoichiro NISHIMURA, Kitakyushu-shi (JP)

(21) Appl. No.: 19/240,037

(22) Filed: Jun. 17, 2025

(30) Foreign Application Priority Data
Jun. 17, 2024 (JP) 2024-097279

(51) Int. Cl. B65H 31/36; H04N 1/00

(52) U.S. Cl. CPC B65H 31/36; H04N 1/00631; B65H 2404/721; H04N 2201/0081

(57) ABSTRACT

A medium discharge device 3 includes a medium discharge section 30 that discharges a medium M in a discharge direction, a placement section 14 having a placement surface 40 on which the medium M discharged from the medium discharge section 30 is placed; and a medium stopper 45 that is provided at an end section of the placement section 14 in the discharge direction and that restricts movement of the discharged medium M in the discharge direction, wherein the medium stopper 45 rises upright with respect to the placement surface 40, has a first contact surface S1 configured to come into contact with a downstream end of the discharged medium M in the discharge direction, and has a second contact surface S2 that is located above the first contact surface S1 and that is configured to come into contact with a downstream end of the discharged medium M in the discharge direction.

The present application is based on, and claims priority from JP Application Serial Number 2024-097279, filed Jun. 17, 2024, the disclosure of which is hereby incorporated by reference herein in its entirety.

### BACKGROUND

### 1. Technical Field

The present invention relates to a medium discharge device and an electronic device.

### 2. Related Art

JP-A-2017-065830 describes an image forming device that is equipped with a discharge tray for receiving sheet material discharged from a device main body section and a sheet stopper arranged on the discharge tray. This sheet stopper has an axis section and is rotatable between a retreat position and an upright position. This sheet stopper, in the upright position, prevents the sheet material on the discharge tray from moving.

However, the sheet stopper disclosed in JP-A-2017-065830 is composed of only an inclined plane, so it is possible that the discharged sheet material may climb over the sheet stopper and deviate outside the device.

### SUMMARY

A medium discharge device includes a medium discharge section that discharges a medium in a discharge direction; a placement section having a placement surface on which the medium discharged from the medium discharge section is placed; and a medium stopper that is provided at an end section of the placement section in the discharge direction and that restricts movement of the discharged medium in the discharge direction, wherein the medium stopper rises upright with respect to the placement surface, has a first contact surface configured to come into contact with a downstream end of the discharged medium in the discharge direction, and has a second contact surface that is located above the first contact surface and that is configured to come into contact with a downstream end of the discharged medium in the discharge direction.

An electronic device includes the medium discharge device.

### BRIEF DESCRIPTION OF THE DRAWINGS

FIG. 1 is a perspective view showing a schematic configuration of an image reading device.

FIG. 2 is a sectional view showing an internal configuration of the image reading device.

FIG. 3 is a perspective view showing a configuration of a placement section.

FIG. 4 is a side cross-sectional view of the placement section showing an upright state of a medium stopper.

FIG. 5 is the side cross-sectional view of the placement section showing a retracted state of the medium stopper.

FIG. 6 is a side view showing a configuration of the medium stopper.

FIG. 7 is a front view showing the configuration of the medium stopper.

FIG. 8 is a partially enlarged view of the medium stopper.

FIG. 9 is a front view showing a configuration of the medium stopper in a modified example.

FIG. 10 is a front view showing the configuration of the medium stopper in another modified example.

### DESCRIPTION OF EMBODIMENTS

Hereinafter, a configuration of a medium discharge device 3 according to an embodiment will be described with reference to the drawings. The medium discharge device 3 is mounted on an electronic device such as an image reading device 1. The image reading device 1 is an electronic device that reads an image formed on a medium M such as a transported sheet and generates image data.

Each drawing shows an X axis, a Y axis, and a Z axis intersecting each other. In the present embodiment, the X axis, the Y axis, and the Z axis are orthogonal to each other. The X axis is parallel to a placement surface of the image reading device 1, and corresponds to a width direction of the image reading device 1. The Y axis is parallel to the placement surface of the image reading device 1, and corresponds to a depth direction of the image reading device 1. The Z axis is perpendicular to the placement surface of the image reading device 1, and corresponds to a height direction of the image reading device 1.

Hereinafter, a +X direction, which is parallel to the X axis, is a left direction as viewed from a front surface of the image reading device 1. A −X direction, which is parallel to the X axis, is a direction opposite to the +X direction. A +Y direction, which is parallel to the Y axis, is a direction that goes from a rear surface of the image reading device 1 toward the front surface. A −Y direction, which is parallel to the Y axis, is a direction opposite to the +Y direction. A +Z direction, which is parallel to the Z axis, is a direction that goes upward from the placement surface of the image reading device 1. A −Z direction, which is parallel to the Z axis, is a direction opposite to the +Z direction. In the present embodiment, the ±Z directions are parallel to the vertical direction.

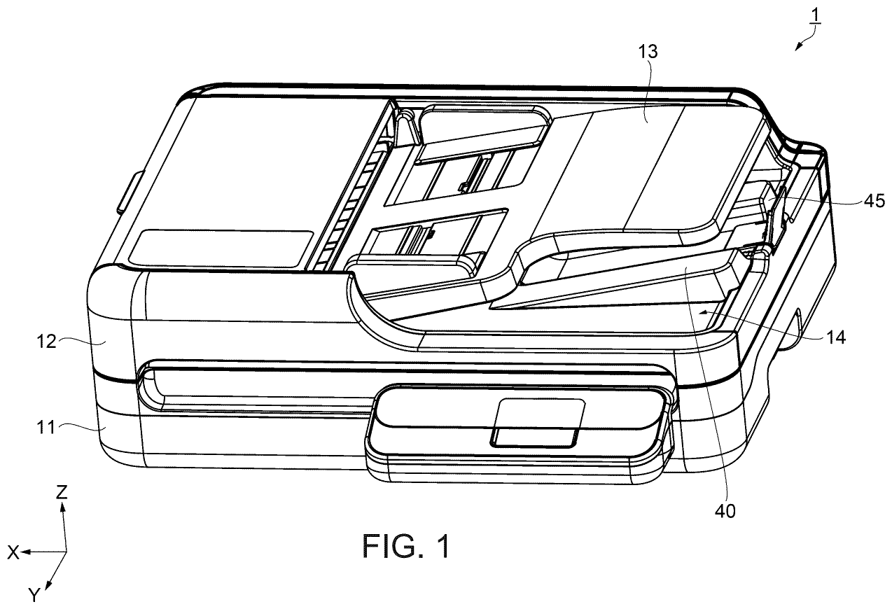

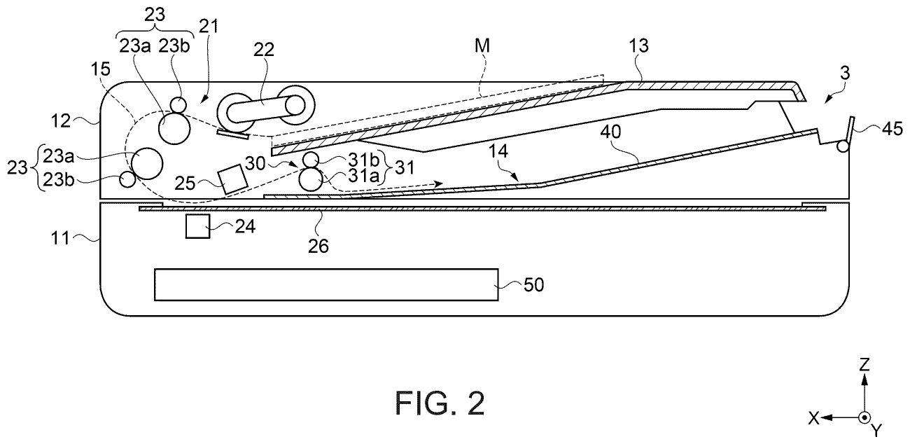

As shown in FIG. 1, the image reading device 1 is equipped with a lower unit 11 and an upper unit 12. The upper unit 12 is arranged above the lower unit 11. The upper unit 12 includes a sheet feed section 13 on which a medium M before reading is placed, and a placement section 14 on which a medium M after reading is placed. Plural sheets of medium M (see FIG. 2) can be placed on the sheet feed section 13 and the placement section 14 so that the medium M is stacked on it. The upper unit 12 can be opened and closed with respect to the lower unit 11.

As shown in FIG. 2, in the upper unit 12 of the image reading device 1, a transport path 15 for the medium M is formed, as shown by broken line. The transport path 15 is a path that passes through the inside of the upper unit 12 from the sheet feed section 13, passes between the lower unit 11 and the upper unit 12, then reaches the placement section 14. The transport path 15 is bent in the upper unit 12.

The image reading device 1 is equipped with a medium transport section 21 inside the upper unit 12. The medium transport section 21 includes a feed unit 22 and a plurality of transport roller pairs 23. The feed unit 22 separates an uppermost sheet of medium M from the plurality of medium M stacked on the sheet feed section 13 and takes the medium M into the transport path 15 one sheet at a time. The transport roller pair 23 includes a drive roller 23a that rotates by being driven by a drive device (not shown), and a driven roller 23b that rotates following the rotation of the drive roller 23a. The transport roller pair 23 transports the medium M by nipping the medium M with the drive roller 23a and the driven roller 23b. The medium transport section 21 transports the medium M along the transport path 15 toward the discharge roller pair 31 (to be described later). A medium discharge section 30 is an example of the transport section.

The image reading device 1 is equipped with a first sensor unit 24 and a second sensor unit 25 at positions adjacent to the transport path 15. The first sensor unit 24 and the second sensor unit 25 are equipped with, for example, a CIS (Contact Image Sensor) type sensor extending along the Y axis. However, the sensor equipped in the first sensor unit 24 and the second sensor unit 25 may be a sensor of another type, such as a charge-coupled device (CCD) type sensor.

The first sensor unit 24 is housed in the lower unit 11. A light transmittable document table 26 is arranged on the upper surface of the lower unit 11. The first sensor unit 24, through the document table 26, faces a first surface of the medium M being transported. The first sensor unit 24 reads an image formed on the first surface of the medium M being transported. Note that the first sensor unit 24 is movable in the +X direction, and in addition to the medium M being transported along the transport path 15, it can read an image of the medium M placed on the document table 26 by opening the upper unit 12.

The second sensor unit 25 is housed in the upper unit 12 and is arranged on the downstream side from the first sensor unit 24 in the transport path 15. The second sensor unit 25 faces a second surface, which is opposite to the first surface of the medium M being transported, and reads an image formed on the second surface.

The image reading device 1 is equipped with a medium discharge section 30 on the downstream side of the transport path 15 of the medium transport section 21, the first sensor unit 24, and the second sensor unit 25. The medium discharge section 30 discharges the medium M that has been read by the first sensor unit 24 and the second sensor unit 25 toward the placement section 14. Note that the medium discharge section 30, the placement section 14, and a medium stopper 45 (to be described later) constitute the medium discharge device 3.

The medium discharge section 30 has a discharge roller pair 31 composed of a first roller 31a and a second roller 31b. The first roller 31a is rotated by the drive of a drive device (not shown). The second roller 31b is located above the first roller that is, on the +Z direction side, and rotates following the rotation of the first roller 31a. The discharge roller pair 31 nips the medium M with the first roller 31a and the second roller 31b, and discharges the medium M toward the placement section 14. The discharge roller pair 31 is an example of a roller pair. Hereinafter, a direction in which the medium discharge section 30 discharges the medium M is referred to as a discharge direction. In the present embodiment, the discharge direction is substantially the −X direction. The +Y direction intersecting the discharge direction is also referred to as a width direction of the medium M.

The image reading device 1 is equipped with a control section 50 in the lower unit 11. The control section 50 is equipped with a processor such as a central processing unit (CPU) and controls operations of the image reading device 1. In other words, the control section 50 controls operations of the medium transport section 21, the first sensor unit 24, the second sensor unit 25, and the medium discharge section 30.

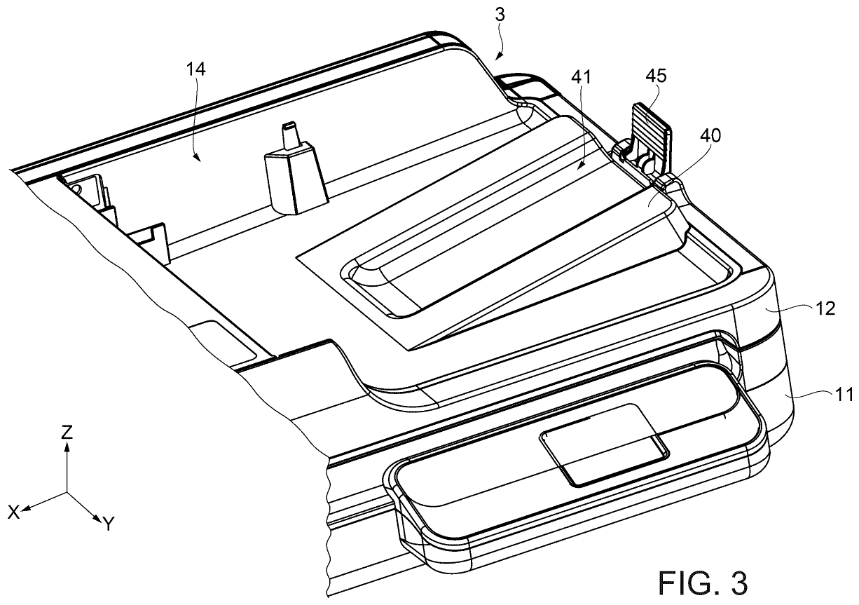

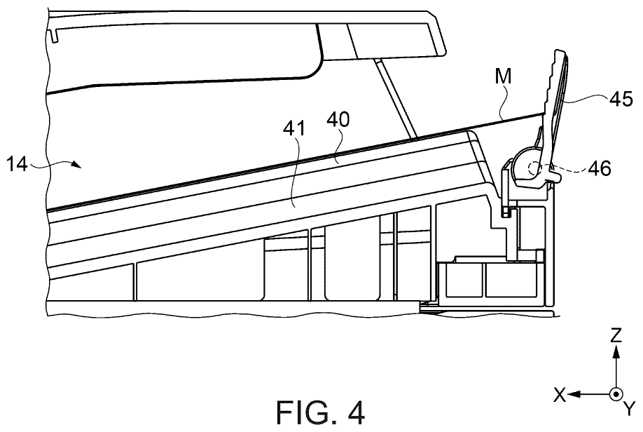

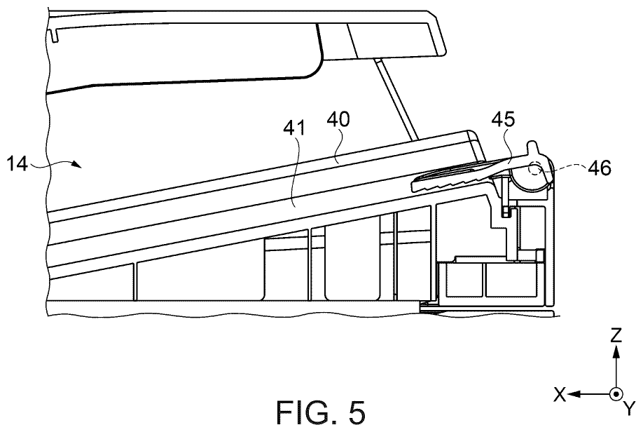

FIG. 3 is a perspective view showing the placement section 14, and FIGS. 4 and 5 are side cross-sectional views of the placement section 14 as viewed from the width direction of the medium M. Note that in FIG. 3, the sheet feed section 13 and the like are not shown so that the placement section 14 can be seen. As shown in FIGS. 3 and 4, the medium M discharged from the medium discharge section 30 is placed on the placement section 14. The placement surface 40 is inclined so that the downstream side in the discharge direction is located further upward than the upstream side. In the placement section 14, a recess section 41 that extends in the ±X direction and is recessed in the −Z direction is formed at the ±Y direction center of the placement surface 40.

A medium stopper 45 is arranged on the downstream side of the placement section 14 in the discharge direction, that is, on the end section of the −X direction side. The medium stopper 45 is provided at the central portion in the ±Y direction, that is, at a position corresponding to the recess section 41 of the placement surface 40. The medium stopper 45 is provided at an end section of the placement section 14 in the discharge direction and restricts a movement of the discharged medium M in the discharge direction.

The medium stopper 45 has a rotation shaft section 46 at a lower portion thereof that extends in the +Y direction and that is rotatable about the rotation shaft section 46. Therefore, as shown in FIG. 5, the medium stopper 45 can be displaced to a lying down state that lies along the placement surface 40. The medium stopper 45 is housed in the recess section 41 in the lying down state. In this way, the medium stopper 45 is rotatable between a retracted state, in which it is housed in the recess section 41 provided in the placement section 14, and an upright state, in which it rises upright with respect to the placement surface 40.

The medium stopper 45, by rotational resistance of the rotation shaft section 46, can also maintain an intermediate position between the upright state and the retracted state.

In the upright state, the medium stopper 45 extends in an oblique direction having a +Z direction component and a −X direction component. Hereinafter, a direction in which the medium stopper 45 extends in the upright state is also referred to as an upright direction E of the medium stopper 45.

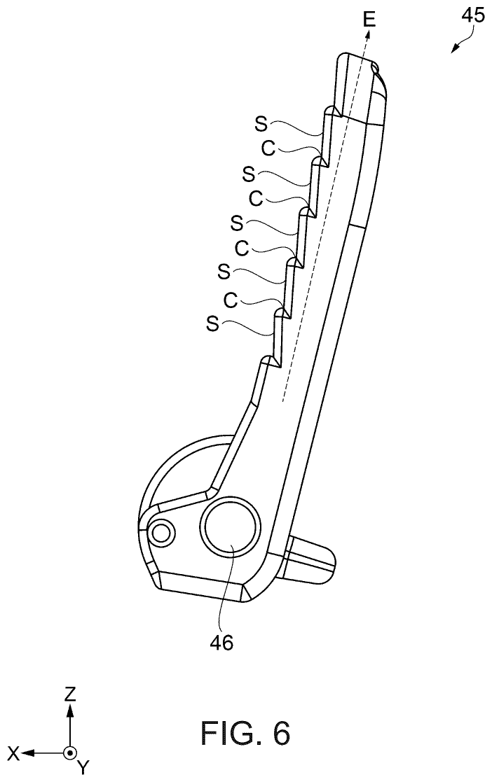

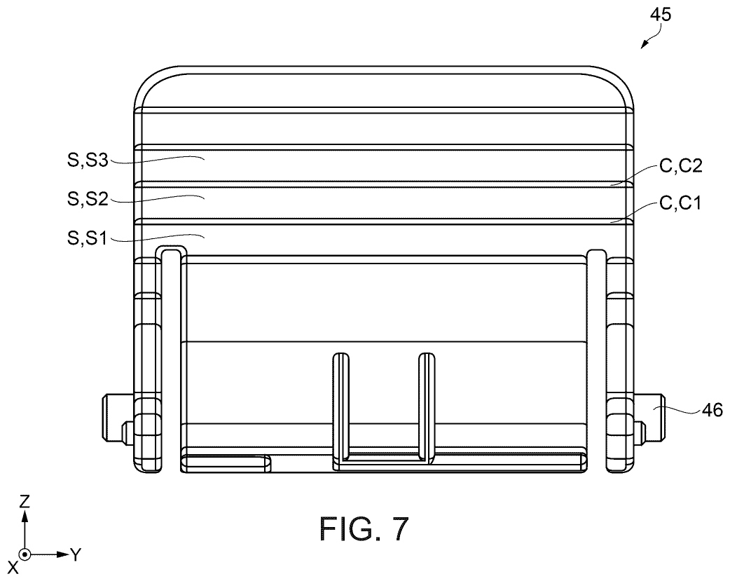

FIG. 6 is a side view of the medium stopper 45 as viewed along the width direction of the medium M, and FIG. 7 is a front view of the medium stopper 45 as viewed along the discharge direction. As shown in FIGS. 6 and 7, a surface of the medium stopper 45 on the +X direction side, that is, the surface of the medium stopper 45 on the placement section 14 side, is formed in a stair-like shape such with steps that are continuous in the vertical direction. In other words, on the surface of the medium stopper 45 on the +X direction side, a plurality of contact surfaces S that constitute the steps are arranged in the vertical direction. Each of the contact surfaces S is a plane that intersects with the discharge direction, and extends along the +Y direction, which is the width direction of the medium M. In the present embodiment, the contact surfaces S extend over the entire area of the width direction of the medium stopper 45. Two contact surfaces S adjacent to each other in the vertical direction are connected by a connection surface C. The connection surface C is a surface along the discharge direction.

The plurality of contact surfaces S come into contact with the downstream end of the medium M discharged onto the placement surface 40 in the discharge direction. If the number of medium M placed on the placement surface 40 is small, the medium M comes into contact with a lower side contact surface S. Then, as the number of medium M to be placed on the placement surface 40 increases, the medium M comes into contact with an upper side contact surface S.

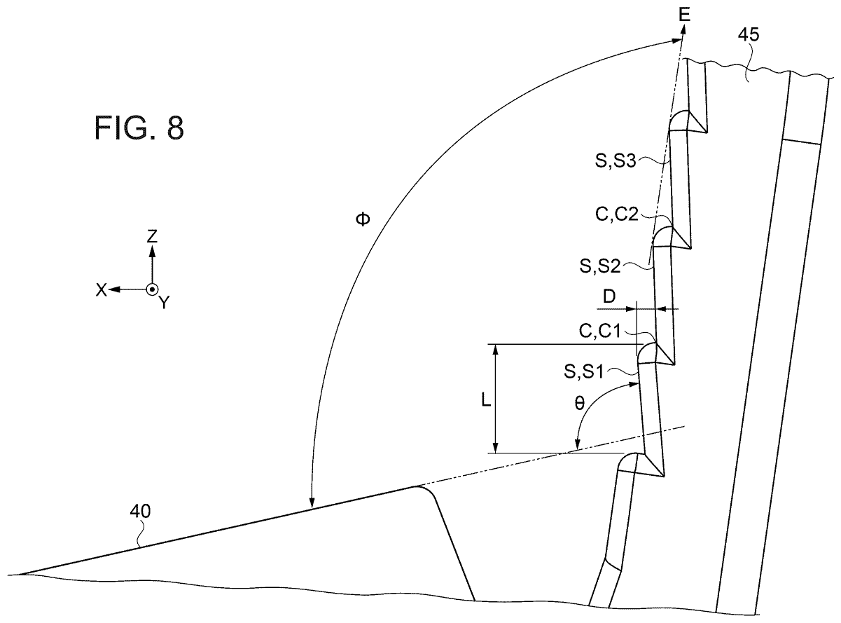

FIG. 8 is a partially enlarged view of the medium stopper 45 as viewed along the width direction of the medium M. As shown in FIG. 8, the plurality of contact surfaces S include a first contact surface S1, a second contact surface S2, and a third contact surface S3. The second contact surface S2 is a contact surface S adjacent to the first contact surface S1 and is located in the upward direction of the first contact surface S1. The first contact surface S1 and the second contact surface S2 are connected by sandwiching a first connection surface C1. The third contact surface S3 is a contact surface S adjacent to the second contact surface S2, and is located in the upward direction of the second contact surface S2. The second contact surface S2 and the third contact surface S3 are connected by a second connection surface C2.

A corner section where the contact surface S intersects with the connection surface C that is connected to an upper side of the contact surface S forms a protrusion. In other words, the medium stopper 45 can also be considered to be a structure with a plurality of protrusions in the vertical direction. The upright direction E of the medium stopper 45 described above can be restated as a direction in which a straight line connecting the top portions of the protrusions extends.

When viewed along the width direction of the medium M, the contact surfaces S of the medium stopper 45 in the upright state are generally along the vertical direction. In addition, in this state, the connection surfaces C are substantially along the discharge direction. A contact surface S is arranged shifted in the −X direction, that is, in the discharge direction with respect to a contact surface S adjacent to the lower side thereof. Specifically, the second contact surface S2 is arranged shifted further in the discharge direction than the first contact surface S1, and the third contact surface S3 is arranged shifted further in the discharge direction than the second contact surface S2.

A dimension D of the connection surfaces C as viewed along the width direction of the medium M is less than a dimension L of the contact surfaces S as viewed along the width direction of the medium M. In other words, when viewed in the width direction of the medium M, the dimension D of the first connection surface C1 is less than the dimension L of the first contact surface S1 and the second contact surface S2. Therefore, it is possible to reduce the dimension of the medium stopper 45 along the discharge direction, and to make the medium stopper 45 thinner. Note that the dimension L of the contact surface S may be the same for all contact surfaces S, or may be different for each contact surface S. Similarly, the dimension D of the connection surfaces C may be the same for all connection surfaces C, or may be different for each connection surface C.

When viewed along the width direction of the medium M, assuming that the angle formed by the placement surface 40 and the contact surface S is θ, θ is desirably 60° or more and 120° or less. In other words, when viewed along the width direction of the medium M, the angle formed by the placement surface 40 and the first contact surface S1, and the angle formed by the placement surface 40 and the second contact surface S2, are desirably 60° or more and 120° or less. If θ is within this range, the medium stopper 45 can appropriately stop the medium M discharged along the placement surface 40 in front of the medium stopper 45. If θ is less than 60°, there is concern that the medium M, after coming into contact with the contact surface S, may be curved so that the downstream side end section of the medium M faces downward. If θ exceeds 120°, there is concern that the medium M, after coming into contact with the contact surface S, may advance upward along the contact surface S and climb over the medium stopper 45. Note that in order to stop the medium M more appropriately, it is more desirable that 0 is 75° or more and 105° or less. The angles formed by the placement surface 40 and the contact surface S may be the same for all contact surfaces S, or may be different for each contact surface S.

When viewed along the width direction of the medium M, assuming that the angle formed by the placement surface 40 and the upright direction E of the medium stopper 45 is φ, φ is desirably 90° or more and 135° or less. If φ is within this range, it is possible to suppress the medium stopper 45 from largely protruding from the housing of the upper unit 12 in the −X direction, and it is possible to easily take out the medium M placed on the placement surface 40. In order to further suppress the protrusion of the medium stopper 45 and to make it easier to take out the medium M, it is more desirable that φ is 105° or more and 120° or less.

As described above, according to the medium discharge device 3 and the image reading device 1 of the present embodiment, the following effects can be obtained.

According to the present embodiment, the downstream end of the medium M discharged in the discharge direction from the medium discharge device 3 comes into contact with one of the plurality of contact surfaces S including the first contact surface S1 and the second contact surface S2, and the medium M is stacked onto the placement section 14. Therefore, it is possible to suppress the discharged medium M from climbing over the medium stopper 45 and deviating outside the medium discharge device 3.

According to the present embodiment, it is possible to house the medium stopper 45 in the recess section 41. By this, by keeping the medium stopper 45 in the retracted state when the medium M is not discharged from the medium discharge device 3, it is possible to prevent damage to the medium stopper 45.

According to the present embodiment, since the upper contact surface S is shifted further in the discharge direction than the lower contact surface S, it becomes possible to easily take out the medium M placed on the placement surface 40.

According to the present embodiment, the medium M discharged from the medium discharge device 3 in the discharge direction can also come into contact with the third contact surface S3 in addition to the first contact surface S1 and the second contact surface S2. Therefore, even when a large number of sheets of the medium M is stacked on the placement surface 40, it is possible to prevent the medium M from deviating by the medium stopper 45.

According to the present embodiment, the first contact surface S1 and the second contact surface S2 extend along the width direction of the medium M that intersects with the discharge direction. The medium stopper 45 receives the downstream end of the medium M with the entire width dimension of the medium stopper 45, so it is possible to prevent the medium M from rotating around a vertical axis when it comes into contact with the medium stopper 45.

According to the present embodiment, since the dimension D of the connection surfaces C is less than the dimension L of the contact surface S when viewed along the width direction of the medium M, it is possible to reduce the thickness direction dimension of the medium stopper 45 and to make the medium stopper 45 thinner.

According to the present embodiment, since the placement surface 40 is inclined so that the downstream side of the discharge direction is located further upward than the upstream side, it is possible for the medium M to be pressed against the upstream end of the placement section 14 by gravity and to be aligned.

According to the present embodiment, when viewed along the width direction of the medium M, the angle formed by the placement surface 40 and the contact surface S is 60° or more and 120° or less, therefore, the medium M can be stacked on the placement surface 40 in a good state.

In addition, according to the present embodiment, when viewed along the width direction of the medium M, the angle formed by the placement surface 40 and the upright direction E of the medium stopper 45 is 90° or more and 135° or less, therefore, it is possible to suppress the medium stopper 45 from largely protruding from the housing of the upper unit 12 in the −X direction, and to easily take out the medium M placed on the placement surface 40.

Although the present embodiment is based on the above configurations, it is also possible to partially change or omit the configuration within the scope of not departing from the gist of the present disclosure. In addition, the present embodiment and the modifications described below can be implemented in combination with each other as long as there is no technical contradiction. Hereinafter, examples of modifications will be described.

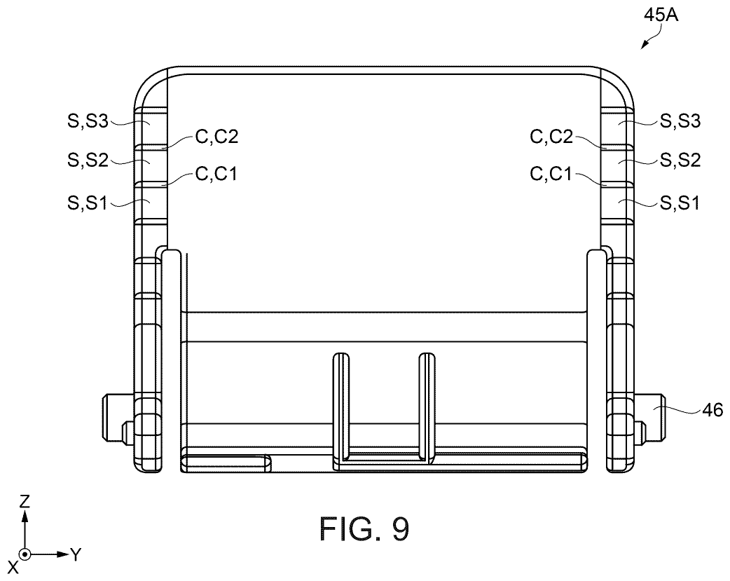

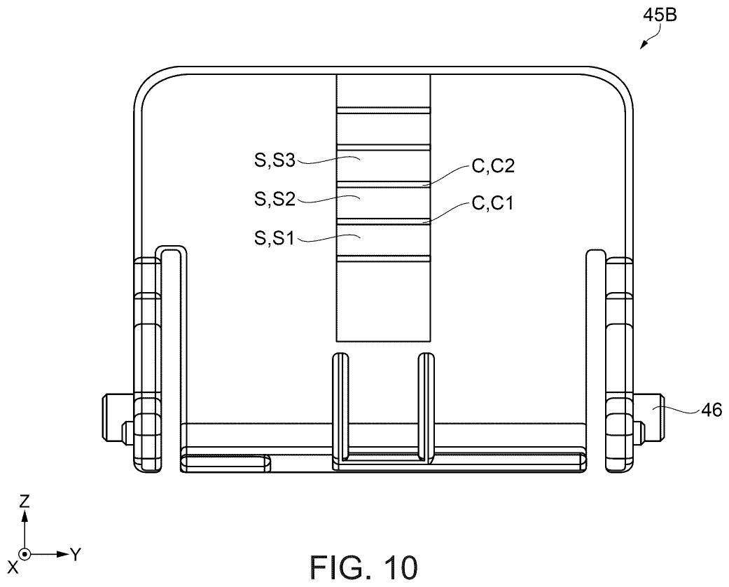

FIGS. 9 and 10 are a front views of the medium stoppers 45A and 45B according to the modification examples. In the embodiment described above, the aspect in which the contact surfaces S of the medium stopper 45 extend over the entire region in the width direction of the medium stopper 45 is described, but an aspect of the contact surfaces S is not limited thereto. For example, as shown in FIG. 9, the contact surfaces S may be formed only at both end portions in the width direction of the medium stopper 45A, or as shown in FIG. 10, the contact surfaces S may be formed only at the center portions in the width direction of the medium stopper 45B. In FIGS. 9 and 10, a portion of the surface where the contact surfaces S is not formed is formed at a position to be further shifted in the discharge direction than the contact surfaces S so that the medium M does not come into contact with it. Even in this case, it is possible to suppress the discharged medium M from climbing over the medium stoppers 45A and 45B and deviating outside the medium discharge device 3.

The medium discharge device 3 in the above-described embodiment is not limited to the configuration equipped in the image reading device 1, and may be equipped in other electronic devices. For example, the medium discharge device 3 may be equipped in an image recording device that records an image on the medium M being transported.

What is claimed is:

1. A medium discharge device comprising:
a medium discharge section that discharges a medium in a discharge direction;
a placement section having a placement surface on which the medium discharged from the medium discharge section is placed; and
a medium stopper that is provided at an end section of the placement section in the discharge direction and that restricts movement of the discharged medium in the discharge direction, wherein
the medium stopper
rises upright with respect to the placement surface,
has a first contact surface configured to come into contact with a downstream end of the discharged medium in the discharge direction, and
has a second contact surface that is located above the first contact surface and that is configured to come into contact with a downstream end of the discharged medium in the discharge direction.

2. The medium discharge device according to claim 1, wherein
the medium stopper is rotatable between a retracted state in which the medium stopper is housed in a recess section provided in the placement section and an upright state in which the medium stopper rises upright with respect to the placement surface.

3. The medium discharge device according to claim 1, wherein
the second contact surface is arranged to be shifted in the discharge direction from the first contact surface.

4. The medium discharge device according to claim 1, wherein
the medium stopper further has, above the second contact surface, a third contact surface configured to come into contact with a downstream end of the discharged medium in the discharge direction.

5. The medium discharge device according to claim 1, wherein
the first contact surface and the second contact surface extend along a width direction of the medium, which intersects with the discharge direction.

6. The medium discharge device according to claim 1, wherein
the first contact surface and the second contact surface are connected by sandwiching a first connection surface and
when viewed along a width direction of the medium intersecting the discharge direction, a dimension of the first connection surface is less than dimensions of the first contact surface and the second contact surface.

7. The medium discharge device according to claim 1, wherein
the placement surface is inclined so that a downstream side of the discharge direction is located further upward than an upstream side.

8. The medium discharge device according to claim 1, wherein
when viewed along a width direction of the medium intersecting the discharge direction, an angle formed by the placement surface and the first contact surface, and an angle formed by the placement surface and the second contact surface, are 60° or more and 120° or less.

9. The medium discharge device according to claim 1, wherein
when viewed along a width direction of the medium intersecting the discharge direction, an angle formed by the placement surface and an upright direction of the medium stopper is 90° or more and 135° or less.

10. An electronic device comprising:
the medium discharge device according to claim 1.
